(19) United States
(12) Patent Application Publication
(10) Pub. No.: US 2002/0142875 A1
(43) Pub. Date: Oct. 3, 2002

(54) Cog belt with entrainers

(75) Inventor: Jorg Rosenberger, Reken (DE)

Correspondence Address: THE FIRM OF KARL F ROSS, 5676 RIVERDALE AVENUE, PO BOX 900, RIVERDALE (BRONX), NY, 10471-0900, US

(73) Assignee: NIENSTEDT GMBH

(21) Appl. No.: 10/107,088

(22) Filed: Mar. 26, 2002

(30) Foreign Application Priority Data
Mar. 27, 2001 (DE) 10114948.4

(51) Int. Cl. F16H 7/02; F16G 1/00; F16G 9/00

(52) U.S. Cl. 474/237; 474/263; 474/153

(57) ABSTRACT

A cog belt has an elongated belt body formed with a multiplicity of longitudinally spaced transversely extending teeth along a longitudinal underside of the belt body and with at least one entrainer for a mold carriage on a longitudinal upper side of the belt body, and a pair of metal plates affixed to opposite lateral sides of the belt body in the region of the entrainer, each of the plates being secured to the entrainer and to at least one of the teeth in the region.

### FIELD OF THE INVENTION

The present invention relates to a cog belt having entrainers on an upper side of the belt for engagement with carriages to displace such carriages, especially mold carriages.

### BACKGROUND OF THE INVENTION

It is known to apply at spaced locations along a cog belt, by adhesive bonding or welding, upwardly projecting formations or entrainers which can engage in the underside of a transport carriage to displace the latter along the path of the belt. Such entrainers can have the configuration of cylindrical or partially cylindrical bodies which can fit into corresponding recesses or structures on the underside of the carriage. This construction can be used for the displacement of mold carriages and the like.

It has been found, in connection with such belts, that the entrainers can come loose after some time or break away fully from the belt.

### OBJECTS OF THE INVENTION

It is the principal object of the invention to provide a cog belt which has greater reliability than earlier systems, especially with respect to the separation of the entraining elements from the belt.

More particularly, it is an object of the invention to provide an improved toothed belt having entraining elements on the upper side thereof engageable in mold carriages and the like and wherein the entraining elements are held more securely to the belt than has hitherto been the case and, especially, so that transverse forces which may be exerted upon the entraining elements will not cause the attachment thereof to loosen or the entraining element to break away from the belt.

### SUMMARY OF THE INVENTION

These objects and others which will become apparent hereinafter are achieved, in accordance with the invention by providing on both sides of the cog belt at each entraining element a respective plate, especially a plate of sheet metal, e.g. a steel plate, which is affixed laterally to the belt, lies against the end of the entraining element and at least two of the teeth or cogs of the belt and which is fastened to the belt and the entrainers and the teeth by pins or bolts extending into the latter. The lateral plates which are secured both to the base of the entrainer and to teeth of the belt at each side of each entrainer securely prevent the separation of the entrainer from the belt. The reinforcement is of simple construction easily assembled to the belt and does not interfere with the operation of the belt either with respect to engagement of the mold carriages by the generally cylindrical projection of the entrainer or the engagement by the teeth or cogs of the cog wheel.

Preferably, the plates are elongated in the longitudinal direction of the cog belt and are mutually parallel on opposite sides of the entraining element. The pins which can extend through the belt transversely to the longitudinal dimension thereof to engage both plates of the respective entraining element, can be four in number for each entraining element and can include two pins through the base of the respective entraining element and two pins through teeth of the belt in the region thereof. In any event at least one pin should pass through the entraining element and at least one pin through a tooth of the belt.

For especially secure retention, the entraining element is formed with a wide base or foot which can span, say, three successive teeth or cogs of the belt and the two pins engaging the plates of that element can pass through the two teeth located along the edges of the wide foot. The plate can thus span over an intermediate tooth.

According to the invention, therefore, a cog belt comprises an elongated belt body formed with a multiplicity of longitudinally spaced transversely extending teeth along a longitudinal underside of the belt body and with at least one entrainer for a mold carriage on a longitudinal upper side of the belt body, and a pair of metal plates affixed to opposite lateral sides of the belt body in the region of the entrainer, each of the plates being secured to the entrainer and to at least one of the teeth in the region.

Advantageously, the entrainer has a rounded head and a base connecting the head with the belt body and having a greater width in the longitudinal direction than the head, the plates being connected to the entrainer by two pins extending through the base, the pins being located respectively at a leading side and at a trailing side of the base with respect to a direction of travel of the belt.

Preferably, the plates are located centrally with respect to a central one of the teeth and have formations laterally abutting a tooth ahead of and a tooth behind the central tooth, the formations having holes and receiving pins traversing the teeth ahead of and behind the central tooth.

It is advantageous for the plates to have bores in which the ends of the pins terminate. Advantageously the spacing of the bores in the plate can be greater than the spacing of the corresponding pins before affixing them in the plates. This facilitates the bending of the belt in the region of the entrainers so that the belt can ride easily around the cog wheel.

### BRIEF DESCRIPTION OF THE DRAWING

The above and other objects, features, and advantages will become more readily apparent from the following description, reference being made to the accompanying drawing in which:

FIG. 1 is a vertical longitudinal section through a portion of a cog belt according to the invention having an entrainer element mounted thereon;

FIG. 2 is an elevational view of a plate affixed to the belt of FIG. 1;

FIG. 3 is a cross sectional view taken along the line III-III of FIG. 1;

FIG. 4 is a side view of a portion of the belt of FIG. 1 before the plate for that side is mounted;

FIG. 5 is a fragmentary side view showing the belt in place; and

FIG. 6 is an elevational view showing another plate configuration which can be used.

### SPECIFIC DESCRIPTION

A cog belt 1 can be provided with an internal reinforcement la, e.g. of glass fiber or fiberglass fabric or even metal wires or fabric, and is formed on its underside with regularly spaced teeth 2 extending transversely to the longitudinal tension represented by the double headed arrow 1b. The teeth 2 are of trapezoidal cross section. On the flat upper side 3 of the belt, entraining elements 4 are also regularly spaced and are fastened to the belt. These entraining elements are profiles which extend transversely to the longitudinal dimension 1b and have cylindrical heads 5 which can engage in recesses in the undersides of carriages which have not been shown. The carriages can be constituted as mold carriages, especially for the molding of foodstuffs.

Each entraining element 4 has a foot or base 6 which is significantly wider than the head 5 and is connected by a neck 4a with the head. The base width BF can be at least twice the head width BK.

The base or foot 6 can extend between two teeth 2 separated by another tooth.

The foot or base 6 has a planar underside and is fastened to the planar upperside 3 by any conventional means. In the embodiment illustrated, the entrainer 4 is disposed centrally over one of the teeth 2 and extends over two teeth 2 on opposite sides of the central tooth. The fastening means may include studs 3a and 3b extending upwardly into recesses in the underside of the base 6. An adhesive or welding connection can be provided.

Each of the two teeth 2 bridged by the base 6 has a respective bore 7 in the form of a horizontal hole running transversely to the longitudinal direction of the belt. In addition, in the base 6 two similar bores 8 are provided at an offset from the neck 4a and are preferably located centrally of the spaces between the teeth of the belt. The spacing between the bores 8 is thus less than that between the bores 7.

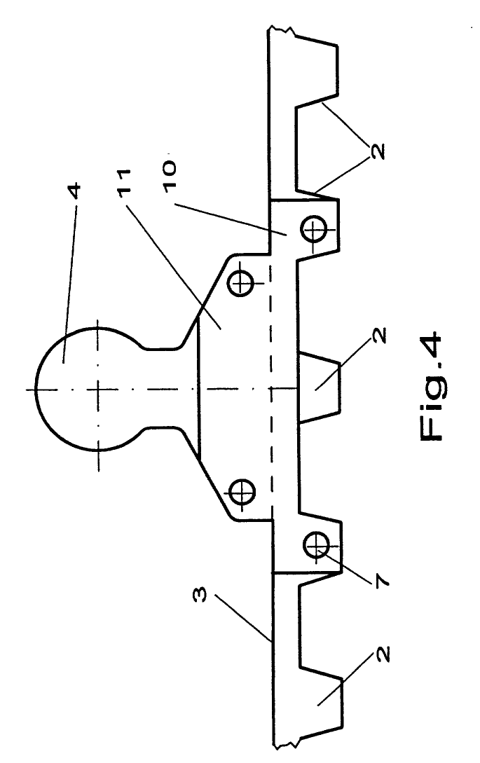

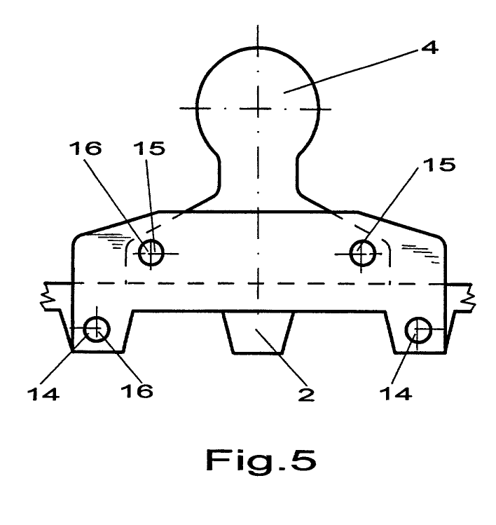

To both sides of the belt 1, at the level of the entrainers 4, plates 9 of sheet metal, i.e. steel plates, are seated in respective recesses 10 (see FIGS. 3 and 4) so that their outer surfaces are flush with the outer surfaces of the belt and the entraining elements 4. The recesses in the entraining elements to receive the plates have been represented at 11 in FIGS. 3 and 4. Thus the end faces 12 of the entraining elements are also flush with the outer surfaces of the plates 9.

The plates 9 have at their lower sides, respective projections 13 at the opposite ends of the plate which have the configuration of the teeth 2 and are received in recesses therein which are the extensions of the recess 10 mentioned previously. Each of the projections 13 has a bore 14 and the plate portion above the projections has a pair of bores 15 which, upon assembly, registered with the bores 8 of the base 6. The bores 14 on assembly registered with the bores 7 in the teeth 2. In the registering bores respective pins 16 are inserted, the ends of the pins lying flush with the outer surfaces of the plates so that the pins do not project both the plates. The plates 9 are fastened by the four pins 16 to the belt 1 and the entrainer 4. This provides a secure retention of the plates to the belt and the entrainer 4 on the belt.

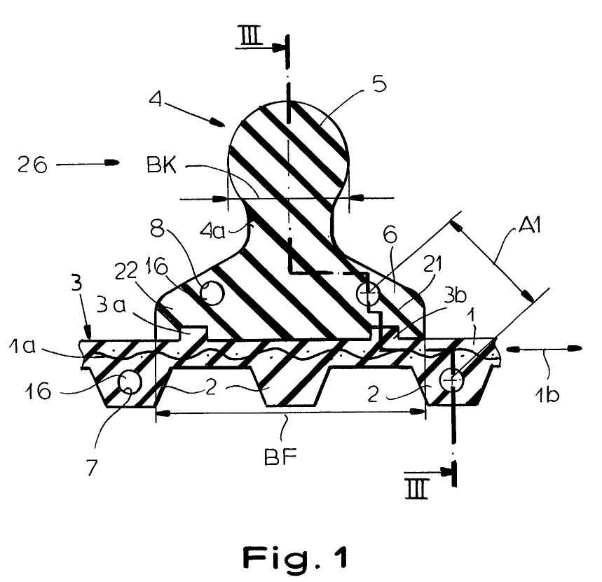

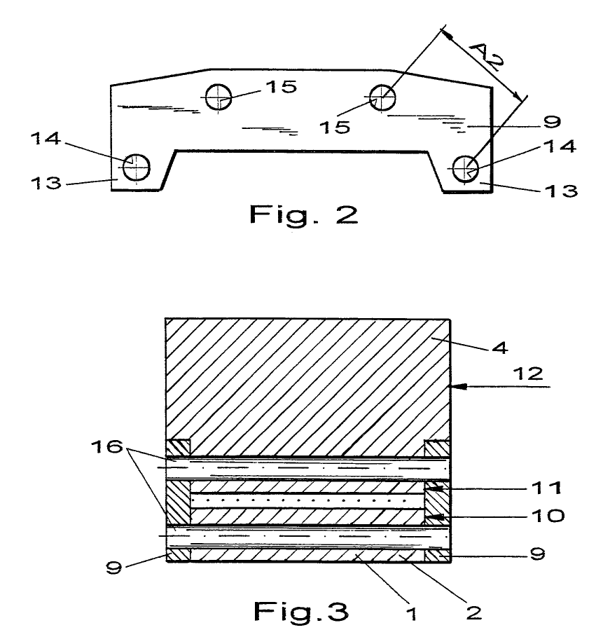

Arrow 26 represents the direction of travel of the belt and with respect to the direction of travel, the base 6 can be seen to have a front side 21 and a rear side 22. The front side has one bore 8 and the rear side another bore 8. These bores 8 are located with their axes defining inclined planes with the front and rear bores 7 in the teeth 2. Thus at the front side 21, there is a bore pair 7, 8 and another bore pair 7, 8 at the rear side. The spacing A1 of the two bores 7 and 8 of one bore pair is not the same as the spacing A2 of the corresponding bores 14 and 15 in the plate 9 (compare FIGS. 1 and 2). The spacing A2 is somewhat greater, i.e. about 0.5 to 2 mm greater than the spacing A1 so that the plate 9, upon assembly, causes the bores 7 and 8 to spread slightly when the pins 16 are in place, thereby imparting a slight bend to the belt 1 in the region of the plates. This makes the entire belt more easily bendable about the cog rollers.

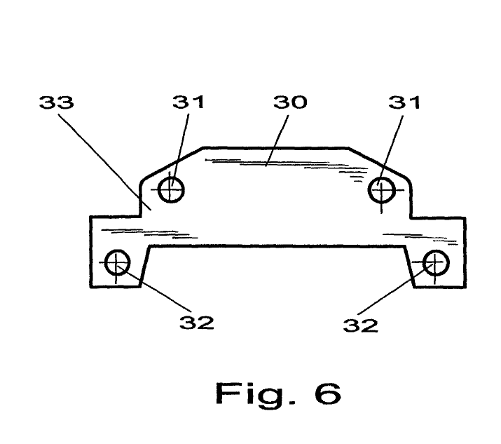

FIG. 6 shows an embodiment in which the outline of a plate 30, which is equivalent to the plates 9, conforms to the contours of the foot or base 6 and the belt and thus has no plate portion projecting beyond the front and back of the plate.

I claim:

1. A cog belt comprising an elongated belt body formed with a multiplicity of longitudinally spaced transversely extending teeth along a longitudinal underside of said belt body and with at least one entrainer for a mold carriage on a longitudinal upper side of the belt body, and a pair of metal plates affixed to opposite lateral sides of said belt body in the region of said entrainer, each of said plates being secured to said entrainer and to at least one of said teeth in said region.

2. The cog belt defined in claim 1 wherein said plates extend parallel to one another and in a longitudinal direction of said belt.

3. The cog belt defined in claim 1 wherein said plates are fastened together and to said entrainer by at least one pin extending transversely to a longitudinal dimension of said belt body.

4. The cog belt defined in claim 3 wherein at least one of said pins extends through said at least one of said teeth.

5. The cog belt defined in claim 3 wherein at least one of said pins extends through said entrainer.

6. The cog belt defined in claim 5 wherein said entrainer has a rounded head and a base connecting said head with the belt body and having a greater width in the longitudinal direction than said head, said plates being connected to said entrainer by two pins extending through said base, said pins being located respectively at a leading side and at a trailing side of the base with respect to a direction of travel of the belt.

7. The cog belt defined in claim 6 wherein said plates are located centrally with respect to a central one of said teeth and have formations laterally abutting a tooth ahead of and a tooth behind said central tooth, said formations having holes and further pins traversing the teeth ahead of and behind the central tooth.

8. The cog belt defined in claim 7 wherein said pins are received at ends of said pins in bores of said plates.

9. The cog belt defined in claim 7 wherein a spacing between the bores in said plates at the same side of the entrainer in the longitudinal direction is greater than the spacing of the pins receivable in said bores before securing the plates on said pins.

10, The cog belt defined in claim 9 wherein a reinforcement inlay is provided in the belt.

11. The cog belt defined in claim 9 wherein said teeth and said entrainer extend the full width of said belt.

12. The cog belt defined in claim 9 wherein said head is generally cylindrical.

13. The cog belt defined in claim 9 wherein said plates are received in recesses on respective lateral sides of the belt body to be flush therewith.

14. The cog belt defined in claim 9 wherein said recesses are shaped to be complementary to said plates.
